(19) United States
(12) Patent Application Publication
(10) Pub. No.: US 2010/0187441 A1
(43) Pub. Date: Jul. 29, 2010

(54) TRANSILLUMINATOR ADAPTOR FOR CONVERSION OF ULTRAVIOLET RADIATION TO VISIBLE LIGHT

(75) Inventors: David E. Waldbeser, Martinez, CA (US); Neeraj Bhatt, Fremont, CA (US); Kevin A. McDonald, Novato, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA (US)

(21) Appl. No.: 12/693,611

(22) Filed: Jan. 26, 2010

Related U.S. Application Data
(60) Provisional application No. 61/147,798, filed on Jan. 28, 2009.

(51) Int. Cl. F21V 9/16; G02B 13/14

(52) U.S. Cl. 250/459.1; 250/461.1

(57) ABSTRACT

An adaptor is designed as an accessory to an ultraviolet transilluminator for the excitation of fluorescent molecules or labels in a planar array of biochemical samples such as a two-dimensional electrophoresis gel to enable the emissions resulting from the excitation to be detected and quantified. The adaptor is constructed to overlay the transilluminator and contains both a fluorescent dye that upon excitation by ultraviolet light emits light in the visible spectrum, and a conditioning substance that selects a portion of the wavelength band of the visible light produced by the fluorescent dye. The adaptor converts the ultraviolet light from the transilluminator to visible light while limiting the emissions reaching the detector to those that emanate from the sample. By the use of this adaptor, the transilluminator is adapted for use with samples labeled with dyes that are excitable by visible light and avoids exposure of the samples and the user to ultraviolet light.

### CROSS REFERENCE TO RELATED APPLICATION

This application claims the benefit of U.S. Provisional Patent Application No. 61/147,798, filed Jan. 28, 2009, the contents of which are incorporated herein by reference.

### BACKGROUND OF THE INVENTION

1. Field of the Invention

This invention resides in the field of detection systems for electrophoretic analyses performed in biochemical laboratories.

2. Description of the Prior Art

A laboratory procedure that is an integral part of nucleic acid and protein research is the separation of nucleic acids or proteins by gel electrophoresis in a slab-shaped gel. This procedure, which is done for identification and quantification of the fragments, separates the fragments into bands, which are then typically stained with a fluorescent dye with an appropriate Stokes shift so that when the gel is irradiated with light at an excitation wavelength the dye emits light at a different wavelength, and the resulting emissions are detected and quantified. Irradiation is commonly achieved by transillumination, i.e., irradiation of the gel at the side opposite the side where detection is performed. A commonly used dye for DNA fragments is ethidium bromide, which is most efficiently excited at wavelengths in the ultraviolet range. Biochemical laboratories are therefore typically equipped with a transilluminator in the form of a light box that contains a UV light source. It is recognized however that nucleic acids are highly susceptible to damage from UV light and that UV light is harmful to the user as well. The use of UV light is therefore of concern not only in the detection of DNA or RNA fragments but also in detections of other species, including proteins and any other fluorescently labeled species in any procedure where a laboratory technician can be exposed to the excitation light.

In view of these concerns, dyes have been developed that are excited by light in the visible range, particularly blue light, since visible range light can be used without detriment to the samples or the user. Examples of these dyes are those sold under the trade name SYBR® Green, cyanine dyes such as Cy2, and fluorescein isothiocyanate (FITC) (Invitrogen, Carlsbad, Calif., USA). Other examples are known to those skilled in the use of fluorescent dyes and DNA detection. Since transilluminators emitting ultraviolet light are widely available and in widespread use, these new dyes have created a need for an inexpensive and quick way to convert the light from an ultraviolet transilluminator to blue, or otherwise visible, light. An attempt to meet this need is disclosed by Kovalsky et al. in U.S. Pat. No. 5,998,789, issued Dec. 7, 1999. Unfortunately, the visible emission spectrum generated by the invention of Kovalsky et al. encroaches on the emission wavelengths of the staining dyes used in the gel, thereby obscuring the image of the bands. Other disclosures include Johanssen et al. U.S. Pat. No. 5,736,744, issued Apr. 7, 1998, and three patents granted to Seville, U.S. Pat. No. 6,198,107 B1, issued Mar. 6, 2001, No. U.S. Pat. No. 6,512,236 B1, issued Jan. 28, 2003, and U.S. Pat. No. 6,914,250 B2, issued Jul. 5, 2005.

### SUMMARY OF THE INVENTION

In accordance with this invention, an adaptor sheet or combination of sheets, flexible or rigid, is placed over the planar light-emitting surface of a transilluminator that otherwise emits ultraviolet light. The adaptor contains (i) a fluorescent dye that upon excitation by ultraviolet light emits light in the visible region, and (ii) a substance that conditions the spectrum of the light emitted by the fluorescent dye to a narrow band that substantially conforms to (is coextensive with or overlaps) the visible-range excitation wavelength band of the dye that has been used to stain the DNA fragments or other species in the gel, without substantially overlapping the emission spectra of the staining dye. Background signals in the gel image are thus minimized or avoided entirely. In cases where the staining dye is one that is excited by two or more wavelength bands of light of which at least one is in the visible range, the conditioned light emerging from the adaptor will be coextensive with or at least overlap at least one of the excitation bands of the staining dye.

The conditioning substance is preferably a non-fluorescing dye, and hence the entire system including the gel in preferred embodiments of the invention will collectively contain at least three dyes: (i) a fluorescent dye in the adaptor, excited by ultraviolet light and emitting light in the visible spectrum, and (ii) a non-fluorescent dye in the adaptor, conditioning the visible light emitted by the fluorescent dye to a narrow band that serves as excitation light for the staining dye in the gel and that does not include wavelengths that are included in the light emitted by the sample, and (iii) a staining dye in the sample, typically fluorescent, that is excited by light in the visible spectrum.

In certain embodiments of the invention, the fluorescent material that upon excitation by ultraviolet light emits light in the visible region and the conditioning substance that passes only the narrow band of visible light that excites the staining dye in the sample reside in separate sheets or layers of the adaptor. The sheet or layer adjacent to the light-emitting surface of the transilluminator in these embodiments contains the fluorescent material and the remaining sheet or layer contains the conditioning substance. The former can be termed a “converter sheet” and the latter a “conditioning sheet,” the converter sheet overlaying the transilluminator and the conditioning sheet overlaying the converter sheet. A converter sheet that emits blue light together with a conditioning sheet that operates as an optical filter to pass only blue light is preferred, although the combination of a red converter sheet and a red conditioning sheet, or a green converter sheet and a green conditioning sheet can also be used. The choice will often depend on the sample or the selection of dyes in the sample. In still further embodiments of the invention, the adaptor contains two or more converter sheets, two or more conditioning sheets, or two or more of each. The use of two or more of either sheet provides further control over the brightness and the bandwidth of the light reaching the gel.

These and other features, objects, and advantages of the invention are explained in more detail below.

### BRIEF DESCRIPTION OF THE DRAWINGS

FIG. 1 is an exploded view in perspective of one example of an adaptor in accordance with the present invention, shown together with a transilluminator and a sample.

FIG. 2 is an exploded view in perspective of a second example of an adaptor in accordance with the present invention, shown together with a transilluminator and a sample.

FIG. 3 is an exploded view in perspective of a third example of an adaptor in accordance with the present invention, shown together with a transilluminator and a sample.

### DETAILED DESCRIPTION OF THE INVENTION AND PREFERRED EMBODIMENTS

Examples of materials that can be used for the adaptor, whether the converter and conditioning functions are performed in a common sheet or in a combination of individual sheets or layers, are polymethyl methacrylates, notably those sold under the trade name ACRYLITE® (Evonik Industries, Sanford, Me., USA). Other examples are polycarbonate, allyl diglycol carbonate, butyrate, glycol-modified polyethylene terephthalate, polyvinyl chloride, and polystyrene. Sheets with fluorescent dyes embedded in the sheet material that emit light in the visible spectrum when excited by ultraviolet light are commercially available and commonly identified by the manufacturer as fluorescent. Specific examples of ACRYLITE sheets are those bearing the product code number 5F21, 5C41, 6175-4, and 5H44. Other examples of materials for the sheets are generally non-autofluorescing or low-autofluorescing sheets that are known to those skilled in the art and commercially available from plastics suppliers.

Examples of fluorescent dyes that are excitable by ultraviolet light are coumarins such as umbelliferone, ALEXA FLUOR 350 maleimide (a thiol-reactive sulfonated coumarin), diethylaminocoumarin, and dimethylaminocoumarin; triazine stilbenes, including di-, tetra-, and hexa-sulfonated triazine stilbenes; biphenyl stilbenes; imidazolines; diazoles; triazoles; benzoxazolines; anilinonaphthalene; benzophenone; bimanes (1,5-diazabicyclo(3.3.0) octadienediones); dansyl (i.e., 5-(dimethylamino)naphthalene-1-sulfonyl) compounds, including dansyl chloride, dansyl glycine, dansyl aziridine, and dansyl cadaverine; Pacific Blue maleimide; and Pacific Orange maleimide. Other examples will be readily apparent to those skilled in the art. Dyes of this type are available from various sources, including Invitrogen (Carlsbad, Calif., USA).

An optional component of the converter sheet is an additive that serves as a light scattering agent. Additives that are insoluble in the matrix material of the sheet and that form inclusions having sizes in the range of about 1 micron to about 1 mm and a refractive index difference of±0.003 to±0.2 relative to the matrix material can be used as light scattering agents. Examples of materials from which these additives can be made are aluminum hydroxide, aluminum potassium silicate, aluminum silicate, barium sulphate, calcium carbonate, magnesium silicate, crosslinked polystyrene, crosslinked polymethyl methacrylate (when the matrix material is other than polymethyl methacrylate), crosslinked polystyrene, and crosslinked polybenzyl methacrylate. Others will be apparent to those skilled in the art.

The conditioning substance or sheet can be any optical filtering material that passes only light of the appropriate wavelength. Such sheets are also commercially available, with bandwidths identified by the manufacturer. An example of a material for a conditioning sheet that allows blue light to pass is an ACRYLITE sheet bearing the product code number 5C28. Examples of non-fluorescing blue dyes that can be incorporated into plastic sheets are Oil Blue A or Blue AP (1,4-bis(isopropylamino)anthraquinone), Chicago blue 4B (an azo dye also known as Pontamine sky blue), and alamarBlue® (also known as resazurin or 7-hydroxy-3H-phenoxazin-3-one 10-oxide). In one preferred embodiment of the invention, a fluorescent dye emitting light over a wavelength range of from about 425 nm to about 575 nm with a peak at about 450 nm to about 490 nm is used as the converter dye, and a non-fluorescent dye that attenuates visible light of wavelengths longer than 530 nm is used as the conditioning substance. In another preferred embodiment, a fluorescent dye emitting light over a wavelength range of from about 490 nm to about 640 nm with a peak at about 510 nm to about 520 nm is used as the converter dye, and a non-fluorescent dye that attenuates visible light of wavelengths longer than 550 nm is used as the conditioning substance. In a third preferred embodiment of the invention, a fluorescent dye emitting light over a wavelength range of from about 590 nm to about 750 nm with a peak at about 615 nm to about 625 nm is used as the converter dye, and a non-fluorescent dye that attenuates visible light of wavelengths longer than 650 nm is used as the conditioning substance. Other combinations will be readily apparent to those skilled in the art, or readily determined by routine experimentation.

The thickness of the adaptor, and of individual sheets when separate sheets are used for the converter and conditioning functions, is not critical but can affect the uniformity and brightness of the light reaching the sample. While sheets of a particular nominal thickness will often have variations in thickness from one sheet to the next or localized thickness variations within individual sheets, non-uniformities can be reduced by increasing the quantity of fluorescent dye or the thickness of the sheet containing the fluorescent dye. In regard to the fluorescent dye, optimal results will generally be obtained by selecting a quantity of the fluorescent dye that will produce bright emission light and yet not cause appreciable quenching of the light thus produced. In regard to the non-fluorescent dye, optimal results will be obtained with a minimal number or density of dye absorption centers while still achieving the desired filtering effect. In both cases, these parameters can be adjusted by varying the thickness of the layer(s), the concentrations of the dyes, or both. When the adaptor is used with a pre-existing transilluminator, mechanical constraints imposed by the transilluminator itself frequently limit the thickness of the adaptor that the transilluminator can accommodate, and therefore adjustments are best made in the quantities of the dyes or in the selection of the dyes themselves. In most applications, best results will be obtained with individual sheets or a single combined sheet having a thickness within the range of about 2 mm to about 25 mm, and preferably from about 2.5 mm to about 20 mm. As presently contemplated, optimal individual converter and conditioning sheets are each 3 mm in thickness.

Another feature is one that will prevent or reduce the occurrence of non-uniform light distribution, such as that caused by optical interference (known as Newton's Rings). This feature can be achieved by providing the converter sheet, the conditioning sheet, or both with a textured surface such as for example a matte finish, on one or both sides. In addition to preventing optical interference, a textured surface can also serve to scatter the light to improve the spatial uniformity of the light across the length and width of the illumination area. In a presently preferred embodiment, a matte finish is present on both sides of the converter sheet and on the upper side of the conditioning sheet (the side not facing the fluorescent sheet).

An alternative to the use of a textured surface on the converter sheet, conditioning sheet, or both is to separate the sheets by a gap whose width is greater than the wavelength of light causing the interference pattern. A still further alternative is the inclusion of an interface material between the converter and conditioning sheets, or between the conditioning sheet and the protective sheet, or both. A useful interface material for this function is one that can be inserted or applied between the sheets with continuous contact with both sheets, that has an optical index of refraction that is approximately equal to that of the conditioning sheet, or is intermediate between the plastic and the glass used for the protective sheet, and that exhibits low autofluorescence. An example of such a material is Optical Gel 0607, a product of Cargille Laboratories, Cedar Grove, N.J., USA. Another is SilGel® 612, a product of Wacker-Chemie AG, Munich, Germany. Other suitable materials will be readily apparent to those skilled in the art. In addition to preventing optical interference, such an interface material will improve the optical admittance, i.e., reduce the reflection at the surfaces of the sheets.

The fluorescent and conditioning plates described above can be supplemented by additional features which, although optional, are preferred in certain applications of the invention. One such feature is the inclusion of a protective sheet between the upper surface of the conditioning sheet and the sample. The protective sheet can protect the surface of the conditioning sheet from physical damage, such as scratches, that can occur during cleaning of the sheet or result from the handling of the sheet by the user. The protective sheet can also serve to prevent staining of the conditioning sheet by dyes from the sample, particularly when the sample is an electrophoresis gel. A glass plate will serve adequately as a protective sheet, and if a glass plate is used, one with low autofluorescence should be used. An example of such a glass is BOROFLOAT® 33 (Schott Glass, Duryea, Pa., USA). When a glass plate or other protective sheet is present, the surface of the sheet that faces the conditioning sheet can be textured for the same reasons as explained above in connection with the converter sheet(s) and the conditioning sheet(s).

In use, the adaptor is placed over the surface of the transilluminator, and the sample on which detection is to be performed is placed over the adaptor. When the adaptor includes a converter sheet and a conditioning sheet, or two or more of each, the sample is placed on the conditioning sheet, or the uppermost conditioning sheet when two or more are used, or on the protective layer above the uppermost conditioning sheet, when such a protective layer is present. The sample can be an electrophoresis gel slab, such as an agarose gel or a polyacrylamide gel. Other sample configurations, such as microtiter plates, microscope slides, cell culture, and Petri dishes, can also be used. Detection is achieved by light emitted from regions of the sample, which will be bands in the case of electrophoresis gels, spots or bands in microscope slides of cell cultures, or individual wells in a microtiter plate. In all cases, the species will be stained with a dye that is excited by light in the visible spectrum. The dyed species can, as noted above, be DNA fragments, nucleic acids in general, or proteins or polypeptides. As an alternative to the use of dyes, certain species have inherent fluorescence and can be excited directly by the visible light. The fluorescence emission resulting from the excitation can then be detected by visual observation, or by automated instrumentation, or recorded on photographic film or by a digital camera or other conventional imaging apparatus. The various possibilities will be readily apparent to those skilled in the art.

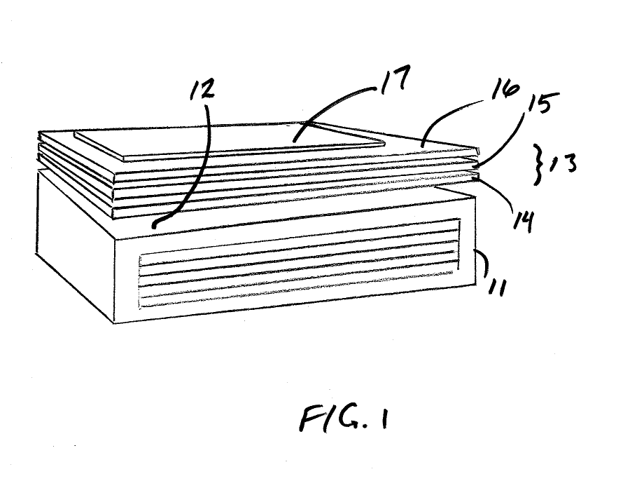

An illustration of an example of an adaptor in accordance with this invention together with a transilluminator and sample are shown in FIG. 1. In this depiction, the transilluminator 11 is a conventional unit emitting UV light from its planar upper surface 12. The adaptor 13 consists of three layers shown in exploded form above the transilluminator. The first of these is a fluorescent converter sheet 14, preferably a sheet of plastic with a fluorescent dye embedded therein, that receives ultraviolet light from the light-transmitting surface 12 of the transilluminator and upon excitation by the ultraviolet light generates emission light that is in the visible range and in the absorption spectrum of the fluorescent molecules, stain, or labels of interest in the sample. Above the converter sheet 14 is a conditioning sheet 15, preferably preferably a sheet of plastic containing a non-fluorescing dye that filters out a portion of the light emitted by the converter sheet to reduce or minimize any spectral overlap between that light and the emission light from the sample. The upper sides of both the converter sheet and the conditioning sheet have matte finishes. Above the conditioning sheet 15 is a protective sheet 16, preferably of glass, to provide mechanical and chemical protection and durability to the converter and conditioning sheets, and to support the sample. Resting on the upper surface of the protective sheet 16 is the sample 17 in the form of an electrophoresis slab gel.

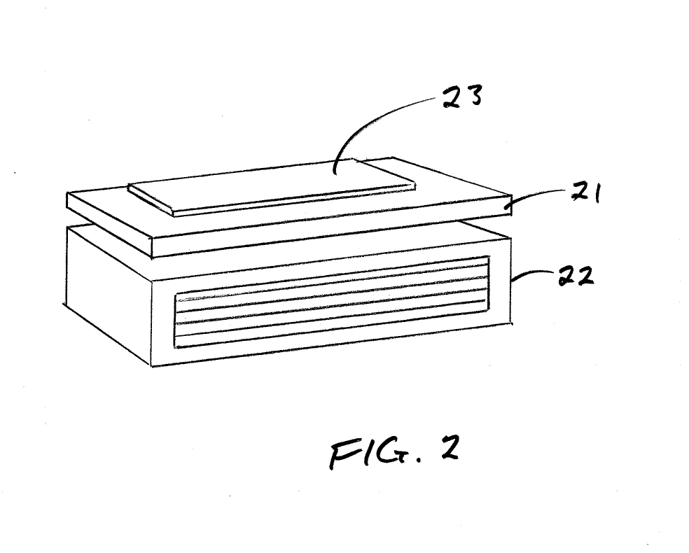

A second example of an adaptor in accordance with the present invention is shown in FIG. 2 together with a transilluminator and sample, in an exploded view. The adaptor 21 in this example is a single sheet that incorporates both the fluorescent dye that converts the ultraviolet light from the transilluminator 22 to light in the visible spectrum, and the non-fluorescent dye that absorbs part of the visible light emitted by the fluorescent dye. The two dyes are either intimately mixed or distributed throughout the adaptor in such a way as to optimize the effectiveness of each dye. This example does not include a protective sheet between the adaptor 21 and the sample 23.

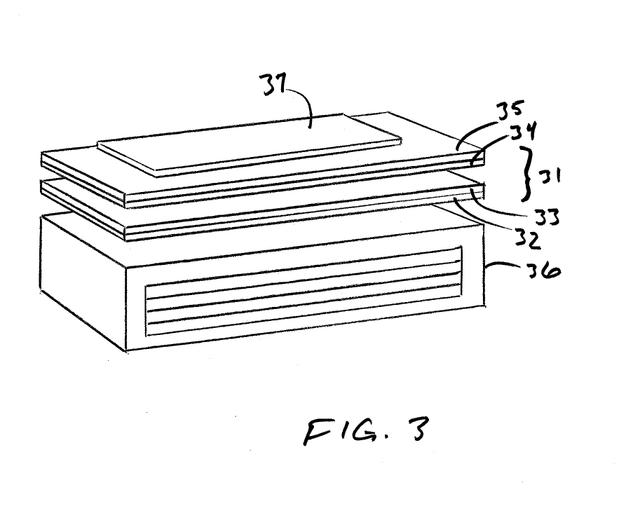

A third example, also in accordance with the invention, is shown in FIG. 3, again in an exploded view including a transilluminator and sample. The adaptor 31 in this example is a combination of sheets, with the fluorescent and non-fluorescent dyes in separate sheets. Two converter sheets 32, 33 and two conditioning sheets 34, 35 are included. The transilluminator 36 and the sample 37 are the same as those in FIGS. 1 and 2. Like the example of FIG. 2, this example does not include a protective sheet between the adaptor 31 and the sample 37.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. Apparatus for use with a transilluminator for transillumination of a planar gel with ultraviolet light, said apparatus to replace said ultraviolet light with light in a visible spectrum before reaching said gel, said apparatus comprising:
a first sheet sized to overlay said transilluminator and having embedded therein a fluorescent dye that upon excitation with ultraviolet light emits light in a visible spectrum; and
a second sheet sized to overlay said first sheet and having embedded therein a non-fluorescent dye that filters out light outside a selected wavelength range in said visible spectrum.

2. The apparatus of claim 1 wherein said fluorescent dye emits light over a wavelength range of about 425 nm to about 575 nm and a peak at about 450 nm to about 490 nm, and said non-fluorescent dye attenuates visible light of wavelengths longer than about 530 nm.

3. The apparatus of claim 1 wherein said fluorescent dye emits light over a wavelength range of about 490 nm to about 640 nm and a peak at about 510 nm to about 520 nm, and said non-fluorescent dye attenuates visible light of wavelengths longer than about 550 nm.

4. The apparatus of claim 1 wherein said fluorescent dye emits light over a wavelength range of about 590 nm to about 750 nm and a peak at about 615 nm to about 625 nm, and said non-fluorescent dye attenuates visible light of wavelengths longer than about 650 nm.

5. The apparatus of claim 1 wherein said first sheet has further embedded therein a light scattering agent.

6. The apparatus of claim 1 wherein said first sheet has a lower side to which said ultraviolet light is incident and an upper side, and said upper side has a matte finish.

7. The apparatus of claim 1 wherein said second sheet has a lower side to which said light emitted by said fluorescent dye is incident and an upper side, and said upper side has a matte finish.

8. The apparatus of claim 1 wherein said first sheet is comprised of a member selected from the group consisting of polymethyl methacrylate, polycarbonate, allyl diglycol carbonate, butyrate, glycol-modified polyethylene terephthalate, polyvinyl chloride, and polystyrene, with said fluorescent dye embedded in said first sheet.

9. The apparatus of claim 1 wherein said first and second sheets are comprised of members selected from the group consisting of polymethyl methacrylate, polycarbonate, allyl diglycol carbonate, butyrate, glycol-modified polyethylene terephthalate, polyvinyl chloride, and polystyrene, with said fluorescent dye embedded in said first sheet.

10. The apparatus of claim 1 further comprising a protective sheet covering said second sheet.

11. The apparatus of claim 1 comprising only one said first sheet and only one said second sheet.

12. The apparatus of claim 1 comprising a plurality of said first sheets and a plurality of said second sheets.

13. A method for illuminating a spatial array of labeled chemical analytes in a planar gel with light in a selected wavelength range in the visible spectrum using an ultraviolet transilluminator, said method comprising:
(a) intercepting ultraviolet light from said transilluminator with a fluorescent dye that upon excitation with ultraviolet light emits light in a visible spectrum; and
(b) passing light emitted by said fluorescent dye through a non-fluorescent dye that filters out light emitted by said fluorescent dye that is outside said selected wavelength range, such that light passing through said non-fluorescent dye is incident upon said gel.

14. The method of claim 13 wherein said fluorescent dye is embedded in a first sheet and said non-fluorescent dye is embedded in a second sheet distinct from said first sheet.

15. The method of claim 13 wherein said fluorescent dye emits light over a wavelength range of about 425 nm to about 575 nm and a peak at about 450 nm to about 490 nm, and said non-fluorescent dye attenuates visible light of wavelengths longer than about 530 nm.

16. The method of claim 13 wherein said fluorescent dye emits light over a wavelength range of about 490 nm to about 640 nm and a peak at about 510 nm to about 520 nm, and said non-fluorescent dye attenuates visible light of wavelengths longer than about 550 nm.

17. The method of claim 13 wherein said fluorescent dye emits light over a wavelength range of about 590 nm to about 750 nm and a peak at about 615 nm to about 625 nm, and said non-fluorescent dye attenuates visible light of wavelengths longer than about 650 nm.

18. The method of claim 14 wherein said first sheet has further embedded therein a light scattering agent.

19. The method of claim 14 wherein said first sheet has a lower side to which said ultraviolet light is incident and an upper side, and said upper side has a matte finish.

20. The method of claim 14 wherein said second sheet has a lower side to which said light emitted by said fluorescent dye is incident and an upper side, and said upper side has a matte finish.

21. The method of claim 14 wherein said first sheet is a comprised of a member selected from the group consisting of polymethyl methacrylate, polycarbonate, allyl diglycol carbonate, butyrate, glycol-modified polyethylene terephthalate, polyvinyl chloride, and polystyrene, with said fluorescent dye embedded in said first sheet.

22. The method of claim 14 wherein said first and second sheets are comprised of members selected from the group consisting of polymethyl methacrylate, polycarbonate, allyl diglycol carbonate, butyrate, glycol-modified polyethylene terephthalate, polyvinyl chloride, and polystyrene, with said fluorescent dye embedded in said first sheet.

23. The method of claim 13 wherein said fluorescent dye and said non-fluorescent dye are together embedded in a single sheet.
